(19) United States
(12) Patent Application Publication
(10) Pub. No.: US 2026/0303742 A1
(43) Pub. Date: Oct. 1, 2026

(54) IMAGE PROCESSING APPARATUSES, CONTROL METHODS, AND STORAGE MEDIUMS

(71) Applicant: CANON KABUSHIKI KAISHA, Tokyo (JP)

(72) Inventor: TOMOHIDE KUBOTA, Kanagawa (JP)

(21) Appl. No.: 19/576,722

(22) Filed: Mar. 24, 2026

(30) Foreign Application Priority Data
Mar. 31, 2025 (JP) 2025-057896

(51) Int. Cl. H04N 1/00

(52) U.S. Cl. CPC H04N 1/00822; H04N 1/0048; H04N 1/00925

(57) ABSTRACT

One or more apparatuses, methods, and storage mediums are provided herein. At least one embodiment of an image processing apparatus may include a scanner that operates to read an original image or images, and one or more processors that operate to display, on a display, image data of the original image or images read by the scanner, wherein, based on an execution of a first reading process in which the original image or images are read by the scanner, the one or more processors further operate to, among a plurality of setting items relating to the first reading process, display, on the display, a setting item for which a second reading process in which reading of the original image or images is executed again is required in a case where a setting value is changed, in a manner such that a requirement for the second reading process is identifiable.

### BACKGROUND

### Field of the Technology

The present disclosure relates to one or more embodiments of image processing apparatuses, control methods, and storage mediums.

### Description of the Related Art

A reading apparatus (scanner) that generates an image file by performing reading processing (scanning) of an original is generally known. The scanner performs scanning (reading) processing based on preset setting values and/or information obtained from an original (or an image file). The setting values can be set in advance by a user through a user interface (UI), such as a touch panel, provided by the reading apparatus, or through a graphical user interface (GUI) available on a personal computer (PC) connectable to the reading apparatus.

Some apparatuses that use such a scanner to scan (read) an original and generate an image file execute a pre-scan and display a preview image of the image file obtained by the pre-scan. After the user has checked the preview image, the apparatuses perform a main scan (i.e., a re-scan). Additionally, a technique has been proposed in which, in a case where a reading setting is changed after the pre-scan, the reading operation of the main scan is changed (see Japanese Patent Laid-Open No. 2023-179889).

### SUMMARY

One or more aspects of the present disclosure are directed to improving usability during scanning.

According to one or more aspects of the present disclosure, one or more embodiments of an image processing apparatus may include a scanner that operates to read an original image or images, and one or more processors that operate to display image data of the original image or images read by the scanner, wherein, based on an execution of a first reading process in which the original image or images are read by the scanner, the one or more processors further operate to, among a plurality of setting items relating to the first reading process, display, on the display, a setting item for which a second reading process in which reading of the original image or images is executed again is required in a case where a setting value is changed, in a manner such that a requirement for the second reading process is identifiable.

According to other aspects of the present disclosure, one or more additional image processing apparatuses, one or more processing methods, and one or more storage mediums are discussed herein. Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating at least one embodiment of an overall configuration of an image processing system according to one or more aspects of the present disclosure.

FIG. 2 is a block diagram illustrating at least one embodiment of a configuration of a multifunction peripheral (MFP) according to one or more aspects of the present disclosure.

FIG. 3 is a block diagram illustrating at least one embodiment of an application configuration according to one or more aspects of the present disclosure.

FIGS. 4A to 4F are diagrams illustrating one or more embodiment examples of screens displayed on an operation unit or on a display according to one or more aspects of the present disclosure.

FIG. 5 is a flowchart illustrating at least one embodiment example of a scan-and-send execution process according to one or more aspects of the present disclosure.

FIGS. 6A and 6B are diagrams illustrating one or more embodiment examples of screens displayed on the operation unit or on a display according to one or more aspects of the present disclosure.

FIG. 7 is a flowchart illustrating at least one embodiment example of a scan-and-send execution process according to one or more aspects of the present disclosure.

FIG. 8 is a flowchart illustrating at least one embodiment example of a scan-and-send execution process according to one or more aspects of the present disclosure.

### DESCRIPTION OF THE EMBODIMENTS

Embodiments of the present disclosure will be described in detail with reference to the accompanying drawings. It should be noted that the embodiments described below do not limit the scope of the present disclosure, and not all combinations of the features described in the embodiments are necessarily essential to the solutions of the present disclosure. Identical components are designated by the same reference numerals.

### Overview for One or More Embodiments

As described above, some image processing apparatuses execute a pre-scan, display a preview image of an image file obtained by the pre-scan, and execute a main scan (re-scan) after the user has completed checking the preview image. At least one image processing apparatus executes a scan-and-send process, in which the apparatus reads an original and transmits image data generated by the reading, based on setting information set by a user. Here, depending on a reading setting (i.e., setting values of respective setting items in scan-and-send process), whether a re-scan process (re-scan), in which the reading process is executed again after a pre-scan, is to be performed (i.e., is required) in a case where the setting value is changed after the pre-scan differs. For example, for a setting item for which processing based on the setting value is performed before reading the original and then a pre-scan is executed, image data based on a changed setting value will not be generated unless a re-scan is performed in one or more embodiments.

If a re-scan is not performed, there may be a case where image data read in the pre-scan is transmitted, rather than image data based on the changed setting value, and thus image data not intended by the user may be transmitted. Thus, to transmit image data based on the changed setting value, a re-scan is to be performed in one or more embodiments. In contrast, for a setting item for which processing based on a setting value is performed after the original is read in the pre-scan but before transmission of image data, a re-scan is unnecessary even in a case where the setting value is changed after the pre-scan because image data based on the changed setting value is generated. However, in one or more embodiments, if the user is not provided with an indication of which reading settings require execution of a re-scan when changed, the user cannot recognize for which reading settings a re-scan is to be executed. For example, it may be considered not to accept a setting-value change for a setting item for which a re-scan is to be performed. In such a case, in a case where the user wishes to change the setting value of such a setting item, the user must set the reading settings again from the beginning, which may reduce usability.

Accordingly, in one or more embodiments, an image processing apparatus operates or is configured to receive a change to a setting value of respective setting items for which a re-scan is to be performed, even in a case where a pre-scan has been executed. Further, in a case where a pre-scan has been executed, the image processing apparatus identifiably displays, among setting items of reading settings, a setting item for which a re-scan is required in a case where a setting value is changed. Specifically, in a case where reading settings have been set and a pre-scan has been executed, the image processing apparatus displays, for a setting item of the reading settings for which a re-scan is required in a case where a setting value is changed, identifiable information (e.g., “!”) that allows identification of the setting item for which a re-scan is required or is to be performed in a case where the setting value is changed. In addition, in a case where a change to a setting value of any setting item for which a re-scan is to be performed is received, the image processing apparatus displays information prompting the user to perform a re-scan. Furthermore, in a case where a change to a setting value of any setting item for which a re-scan is to be performed is received and an instruction to execute a re-scan is provided, the image processing apparatus executes the re-scan.

Thus, even in a case where a pre-scan has been executed, the user may change setting values of the setting items for which a re-scan is to be performed. Further, the user may easily recognize the setting items for which a re-scan is required or is to be performed in a case where their setting values are changed, and may perform an operation to change setting values after recognizing the corresponding setting items and execute a re-scan. Therefore, in one or more embodiments, the user may generate image data based on desired setting values without having to set the reading settings again from the beginning, so that usability is improved.

### One or More Embodiments

One or more embodiments will be initially described. In one or more embodiments, an example form will be described in which, after a pre-scan, scan setting items for which execution of a re-scan is required or is to be performed are displayed in a recognizable manner before execution of the re-scan.

### <System Configuration(s) for One or More Embodiments>

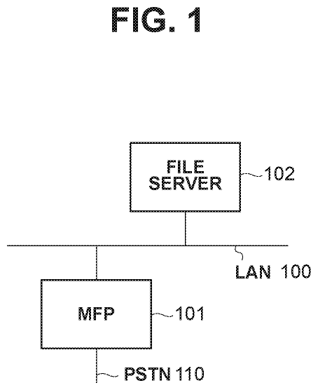

FIG. 1 is a diagram illustrating an example of an image processing system according to one or more embodiments. A local area network (LAN) 100 connects a multifunction peripheral (MFP) 101 and a file server 102 to enable communication with one another. The MFP 101 is an example of an image processing apparatus. The file server 102 is an example of a file management apparatus. The image processing apparatus according to one or more embodiments is not limited to the MFP described above and may be implemented as various devices, such as a personal computer (PC), a smartphone, or a digital camera. The printing method of a printer used in one or more embodiments may be an electrophotographic method, an inkjet method, or another method.

The MFP 101 may transmit image data files using a file transfer protocol to a folder on the file server 102 as a destination. Examples of such protocols include Server Message Block (SMB) and File Transfer Protocol (FTP). The file transmission destination of the MFP 101 is not limited to the file server 102, and a folder in a host PC (not illustrated) may be used as a destination. Additionally, the MFP 101 may transmit image data via electronic mail through a mail server (not illustrated). The MFP 101 is connected to the Public Switched Telephone Network (PSTN) 110 and may perform fax transmission and reception with a fax apparatus (not illustrated). The MFP 101 may be connected to the Internet and configured to transmit data to other devices via the Internet.

The image processing system includes the MFP 101 and the file server 102, but the MFP 101 alone may also constitute the image processing system. Alternatively, the image processing system may include a host PC (not illustrated) or a management server (not illustrated).

### <Hardware Configuration(s) for One or More Embodiments>

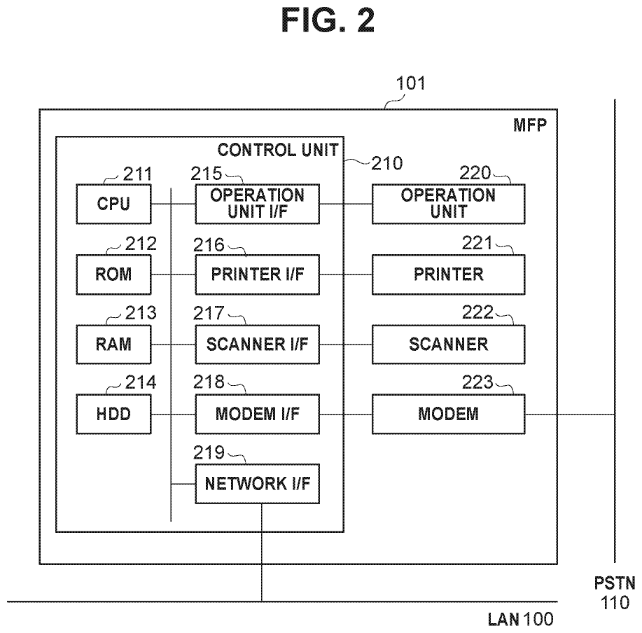

FIG. 2 is a block diagram illustrating an example of at least one hardware configuration of the MFP 101 for one or more embodiments. The MFP 101 includes a control unit 210, an operation unit 220, a printer 221, a scanner 222, and a modem 223. The control unit 210 includes a central processing unit (CPU) 211, a read-only memory (ROM) 212, a random access memory (RAM) 213, a hard disk drive (HDD) 214, an operation unit interface (I/F) 215, a printer I/F 216, a scanner I/F 217, a modem I/F 218, and a network I/F 219.

The control unit 210 including the CPU 211 controls the overall operations of the MFP 101. The CPU 211 reads out control programs stored in the ROM 212 and executes various types of control, such as reading (scanning) control and transmission control. The RAM 213 is used as the main memory of the CPU 211 and as a temporary storage area, such as a work area. In one or more embodiments, it is assumed that one CPU 211 executes the respective processes illustrated in the flowcharts described below using one memory (the RAM 213 or the HDD 214). However, other configurations may also be employed. For example, the MFP 101 may be configured such that a plurality of CPUs and a plurality of RAMs or HDDs operate cooperatively to execute the respective processes illustrated in the flowcharts described below.

The HDD 214 stores image data and various programs. The operation unit I/F 215 connects the operation unit 220 to the control unit 210. The operation unit 220 includes a liquid crystal display (touch panel display) including a touch panel function, a keyboard, and other components.

The printer I/F 216 connects the printer 221 to the control unit 210. Image data used for printing in the printer 221 is transmitted from the control unit 210 to the printer 221 via the printer I/F 216 and printed onto a recording medium by the printer 221.

The scanner I/F 217 connects the scanner 222 to the control unit 210. The scanner 222 reads an image on an original to generate image data (an image file), which is input to the control unit 210 through the scanner I/F 217. The MFP 101 may transmit the image data generated by the scanner 222 by file transfer or by electronic mail.

The modem I/F 218 connects the modem 223 to the control unit 210. The modem 223 connects the control unit 210 (the MFP 101) to the PSTN 110. The modem 223 performs fax transmission and reception with a fax apparatus over the PSTN 110.

The network I/F 219 connects the control unit 210 (in the MFP 101) to the LAN 100. The network I/F 219 transmits image data and information to external devices (such as the file server 102) on the LAN 100 and receives various types of information from external devices on the LAN 100.

### <Software Configuration(s) for One or More Embodiments>

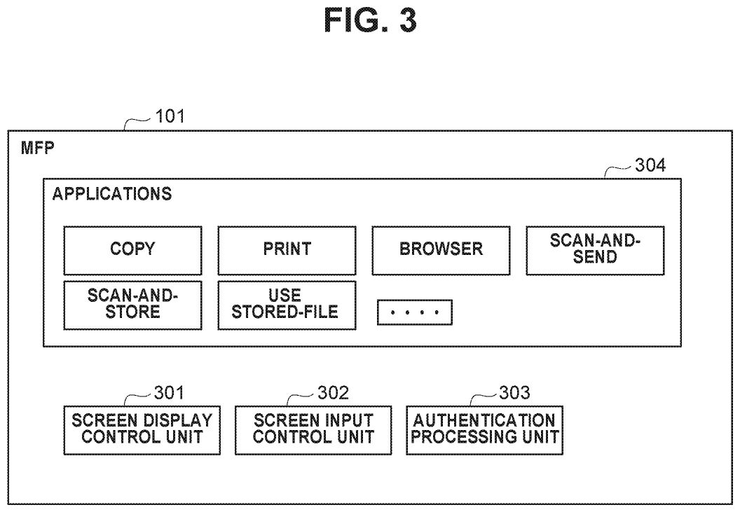

FIG. 3 is a block diagram illustrating at least one embodiment example of a software configuration of the MFP 101. Unless otherwise specified, interactions among the software modules illustrated in FIG. 3 are realized by the CPU 211 performing processing in accordance with programs stored in the ROM 212 or the HDD 214.

A screen display control unit 301 displays, to a user, screens for operating applications (functions) 304.

A screen input control unit 302 receives operations from the user and transfers the received operations to the corresponding application in the applications 304. In one or more embodiments, the screen input control unit 302 receives touch operations performed by the user on the screen display control unit 301 and also receives operations performed using hard keys other than the screen display control unit 301.

An authentication processing unit 303 displays an authentication screen on the operation unit 220 and performs user authentication using authentication information, such as an ID and/or a password, entered by the user. In a case where user authentication succeeds, the authentication processing unit 303 performs login processing to log the authenticated user in to the MFP 101. In a case where a logout instruction is issued, the authentication processing unit 303 performs logout processing to log the currently logged-in user out of the MFP 101.

The applications 304 constitute a group of applications that operate on the MFP 101. According to instructions from the user received through the screen input control unit 302, the CPU 211 causes the corresponding application(s) among the applications 304 to operate. Representative examples of the applications included in the MFP 101 are as follows:
An application program having a “copy” function for causing the printer 221 to print image data generated by reading images from an original through the scanner 222.
An application program having a “print” function for causing the printer 221 to print image data based on a print job supplied from an external device, such as a PC.
An application program having a “scan-and-send” function for reading an image from an original using the scanner 222 to generate image data and transmitting the generated image data to an external destination.
An application program having a “scan-and-store” function for reading an image from an original using the scanner 222 to generate image data and storing the generated image data in external memory.
An application program having a “use stored file” function for causing the printer 221 to print image data stored in external memory or for transmitting image data stored in external memory to an external destination.
An application program having a “browser” function for browsing, printing, and storing data on a web server through a web browser.

The applications 304 included in the MFP 101 are not limited to the examples above. The applications 304 may also be added later according to user instructions.

The at least one configuration illustrated in FIG. 3 is merely an example and is not limited to the illustrated arrangement. Some components illustrated in FIG. 3 may be omitted, and additional components may be included.

### <Operation Screen(s) for One or More Embodiments>

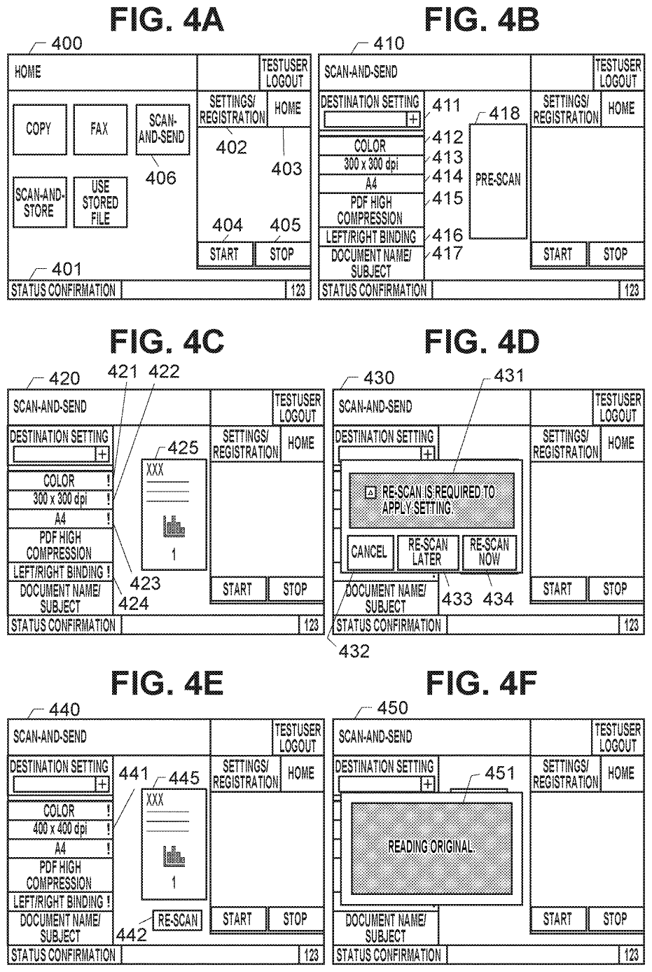

FIGS. 4A to 4F are diagrams illustrating one or more embodiment examples of screens displayed on the operation unit 220. The screens illustrated in FIGS. 4A to 4F are displayed by the screen display control unit 301.

FIG. 4A illustrates an example of a home screen 400. The home screen 400 is displayed when the MFP 101 is activated or in response to a home button 403 being pressed (operated or selected) by the user on another screen. Item regions for using the applications 304 are arranged on the home screen 400, and icon images indicating the respective applications may be displayed in the item regions. In addition, common items that are common to screens other than the home screen 400, including a status confirmation button 401, a settings/registration button 402, a home button 403, a start button 404, and a stop button 405, are displayed. The status confirmation button 401 displays, when pressed by the user, a screen (not illustrated) on which the user may confirm the status of jobs being executed on the MFP 101. The settings/registration button 402 displays, when pressed by the user, a screen (not illustrated) on which the user may confirm and change machine settings. The home button 403 displays the home screen 400 when (or in a case where) pressed by the user while a screen other than the home screen is displayed on the operation unit 220. The start button 404 causes a job to start when pressed by the user during use of an application that executes a scan job and/or a print job. The stop button 405 displays a confirmation pop-up (not illustrated) prompting the user to confirm whether to stop the job, when pressed by the user during job execution. The stop button 405 also displays a warning screen (not illustrated) indicating that no job is being executed, when pressed while no job is being executed. If an OK button is pressed by the user on the confirmation pop-up, the job being executed is canceled. In one or more embodiments, a scan-and-send application 406 is described as an example of an application included in the applications 304 that uses the scanner 222. However, any application using the scanner 222 may be used instead, such as a scan-and-store application.

FIG. 4B illustrates an example of a basic screen of the scan-and-send application (hereinafter referred to as the scan-and-send screen 410), which serves as a predetermined screen. The scan-and-send screen 410 is displayed on the operation unit 220 in response to the scan-and-send application 406 being pressed by the user on the home screen 400. The scan-and-send screen 410 includes a destination-setting button 411, buttons for setting major scan setting items (a color-selection button 412, a reading-resolution button 413, a reading-size button 414, a file-format button 415, a duplex-setting button 416, and a document-name/subject-setting button 417), and a preview region 418. The destination-setting button 411 is used for setting a destination to which image data obtained by scanning an original is transmitted, and destination setting may be performed, for example, by selecting from an address book or by direct entry using a software keyboard. Further, the buttons for setting the major scan setting items enable setting of setting values of scan setting items for execution of reading an original. For example, the reading-resolution button 413 allows items, such as 300 dpi×300 dpi, 400 dpi×400 dpi, and 600 dpi×600 dpi to be set, and FIG. 4B illustrates a state in which 300 dpi×300 dpi is selected. The preview region 418 is used for displaying a preview image of the scanned original. In response to the preview region 418 being pressed, the original is read according to the setting values of the scan setting items (412 to 417) (i.e., a pre-scan is executed), and a preview image is displayed. The pre-scan instruction may be provided not only by the preview region 418 being pressed but also by operation on a start button or another pre-scan-dedicated button. Further, in a case where the pre-scan is executed, a scanning-in-progress screen (FIG. 4F, described below) may be displayed.

FIG. 4C illustrates an example of a scan-and-send screen after the pre-scan (hereinafter referred to as a scan-and-send screen 420). The scan-and-send screen 420 is displayed on the operation unit 220 based on a pre-scan instruction being provided on the scan-and-send screen 410. The scan-and-send screen 420 displays scan-setting items similar to the scan-setting items (412 to 417) displayed on the scan-and-send screen 410. On the scan-and-send screen 420, settings of the scan-setting items may be changed. Compared with the scan-and-send screen 410, the scan-and-send screen 420 further displays “!” icons (marks) on some setting buttons of the major scan-setting items and displays a preview image region 425. A “!” icon is displayed as re-scan identification information on the color-selection button 421, the reading-resolution button 422, the reading-size button 423, and the duplex-setting button 424. The “!” icon indicates that, in a case where a setting value of a scan-setting item for which the “!” icon is displayed is changed, a re-scan is required for the changed setting value to be reflected in the preview image. Setting items for which the changed setting values cannot be reflected in the preview image unless a re-scan is performed are setting items for which, before reading an original, processing based on the setting values of the setting items is performed and then a pre-scan is executed. Specifically, the color-selection setting includes a color mode and a black-and-white mode, and an original is scanned in the selected mode when the original is scanned. Thus, a re-scan is necessary in a case where the setting is changed. In addition, the reading-resolution setting allows various resolution options (e.g., 300 dpi×300 dpi, 400 dpi×400 dpi, and 600 dpi×600 dpi), and requires a re-scan, or instructs a re-scan is to be performed, to change the resolution of the image to be read. The reading-size setting specifies a size at which an original is read, and thus a re-scan is necessary or is to be performed. The duplex setting specifies whether an original is read in single-sided mode or double-sided mode and, in the case of double-sided mode, an original is read in accordance with a binding direction setting, and thus a re-scan is necessary or is to be performed. Setting items for which no “!” icon is displayed are those for which processing based on the setting values is performed after the pre-scan but before transmission of image data and therefore do not require a re-scan (or may not instruct a re-scan to be performed). For example, the file-format setting does not require a re-scan even if the setting value is changed, because the read image is converted into a file format immediately before transmission and then transmitted. Although the “!” icon is described above as an example of re-scan identification information, such an indicator, such an icon, and/or such identification information of the present disclosure is not limited thereto. Another form of icon may be used, text information such as “Re-scan” may be displayed, or colors of the scan-setting items requiring a re-scan may be changed. The preview image region 425 displays a preview image of an original pre-scanned in accordance with a pre-scan instruction. In the example illustrated in FIG. 4C, the preview image region 425 displays a preview image of a first page in one or more embodiments; however, other methods may be used. For example, preview images of a plurality of pages may be displayed within the preview image region 425, or preview images of a plurality of pages may be displayed in another screen layout in response to a preview image being pressed.

FIG. 4D illustrates an example of a re-scan screen 430 that prompts the user to perform a re-scan. The re-scan screen 430 is displayed on the operation unit 220 in response to a setting value of any scan-setting item for which a re-scan is required being changed on the scan-and-send screen 420. The re-scan screen 430 displays a re-scan message 431, a cancel button 432, a re-scan-later button 433, and a re-scan-now button 434. The re-scan message 431 displays information indicating that a re-scan is required to generate image data based on the changed setting value of the scan-setting item and reflect the image data in the preview image region 425 (message: “Re-scan is required to apply setting.”). The cancel button 432 is used for canceling a user-instructed change to a setting item without applying the change. The re-scan-later button 433 is used for making the setting-value change but updating the preview image later. The re-scan-now button 434 is used for making the setting-value change and updating the preview image, and, in response to the re-scan-now button 434 being pressed, a re-scan is executed and the scan-and-send screen 420 including the updated preview image is displayed. During execution of the re-scan, a scanning-in-progress screen (FIG. 4F, described below) may be displayed.

FIG. 4E illustrates an example of a scan-and-send screen 440 in a case where a re-scan is necessary. The scan-and-send screen 440 is displayed on the operation unit 220, for example, in response to the user pressing the reading-resolution button 422 to change the reading-resolution setting from 300 dpi×300 dpi to 400 dpi×400 dpi and pressing the re-scan-later button 433 on the re-scan screen 430. The scan-and-send screen 440 displays a reading-resolution button 441 and a re-scan button 442. The reading-resolution button 441 displays 400 dpi×400 dpi, which is the setting after the setting change. The re-scan button 442 is used for performing a re-scan according to the changed setting value(s) of the scan setting(s), and in response to the re-scan button 442 being pressed, a re-scan is executed.

FIG. 4F illustrates an example of a scanning-in-progress screen 450 that displays information indicating that a re-scan is in progress (message: “Reading original.”). The scanning-in-progress screen 450 is displayed on the operation unit 220 in response to the re-scan-now button 434 on the re-scan screen 430 being pressed or in response to the re-scan button 442 on the scan-and-send screen 440 being pressed. The scanning-in-progress screen 450 displays information 451 indicating that re-scan is in progress (message: “Reading original.”).

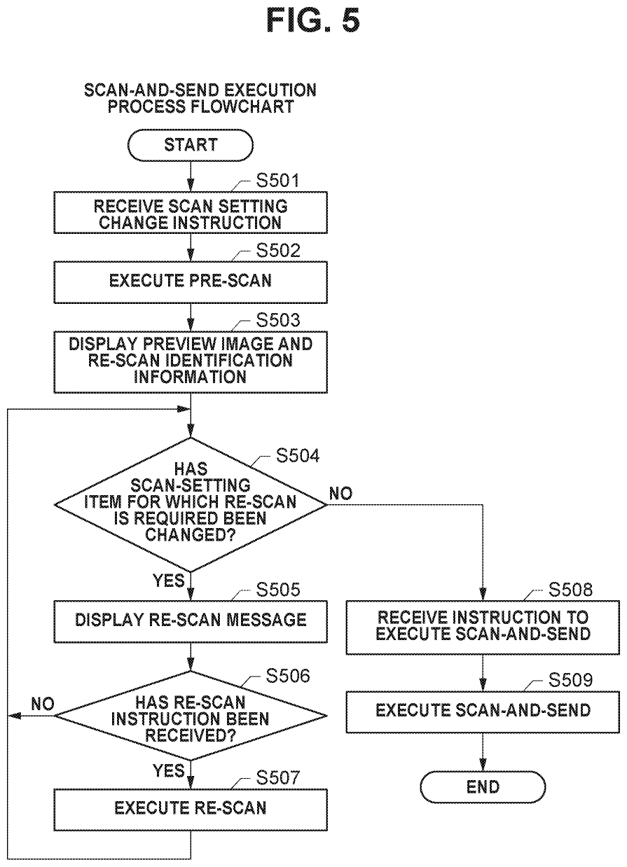

FIG. 5 is a diagram illustrating an example of a flowchart of a scan-and-send execution process (scan-and-send process) according to one or more embodiments. The flowchart illustrated in FIG. 5 is realized by the CPU 211 of the MFP 101 reading, into the RAM 213, programs stored in the ROM 212 for implementing respective control modules and executing the programs. The functions performed in some or all of the steps in FIG. 5 may alternatively be realized in hardware, such as an Application-Specific Integrated Circuit (ASIC) or other electronic circuitry.

The processing in the flowchart illustrated in FIG. 5 is initiated based on the scan-and-send screen 410 being displayed in response to the user pressing the scan-and-send application 406.

In step S501, the screen input control unit 302 receives an instruction from the user to change a setting value of a scan-setting item on the scan-and-send screen 410.

In step S502, in a case where a corresponding application(s) of the applications 304 (hereinafter, simply referred to as the application 304) receive(s) a pre-scan instruction from the user on the scan-and-send screen 410, the application 304 executes a pre-scan of an original. Specifically, in a case where the user presses the preview region 418 illustrated in FIG. 4B, the pre-scan of the original is executed.

In step S503, the screen display control unit 301 displays the preview image region 425 of the scan-and-send screen 420, and displays re-scan identification information (“!” icon) on the corresponding scan-setting item buttons (the color-selection button 421, the reading-resolution button 422, the reading-size button 423, and the duplex-setting button 424).

In step S504, the screen input control unit 302 determines whether the setting value of any scan-setting item for which a re-scan is required has been changed. If it is determined that the setting value of any scan-setting item for which a re-scan is required has been changed (YES, in step S504), the processing proceeds to step S505, and if it is determined that no setting value of any scan-setting item for which a re-scan is required has been changed (NO, in step S504), the processing proceeds to step S508.

In step S505, the screen display control unit 301 displays a screen including information indicating that a re-scan is required to reflect the changed setting value of the scan setting in the preview and a region that allows a re-scan instruction to be issued. Specifically, the screen display control unit 301 displays the re-scan screen 430 in FIG. 4D.

In step S506, the screen input control unit 302 determines whether a re-scan instruction has been received. If the re-scan-now button 434 on the re-scan screen 430 is pressed, the screen input control unit 302 determines that the re-scan instruction has been received (YES in step S506), and the processing proceeds to step S507. If the cancel button 432 is pressed, the screen input control unit 302 determines that the re-scan instruction has not been received (NO in step S506), the setting-value change instructed in step S504 is discarded, and the processing returns to step S504. If the re-scan-later button 433 is pressed, the setting-value change instructed in step S504 is stored. Then, the scan-and-send screen 440 after the setting change is displayed, and, in a case where the re-scan button 442 is pressed, the re-scan in step S507 is executed.

In step S507, the application 304 executes a re-scan of the original, updates the preview image, displays the scan-and-send screen 420 including the updated preview image, and then returns to step S504.

In step S508, the screen input control unit 302 receives an instruction to execute the scan-and-send process. The scan-and-send process is executed in a case where a destination has been set using the destination-setting button 411 and then the start button 404 is pressed.

In step S509, the application 304 executes the scan-and-send process. Specifically, in a case where the setting value of any scan-setting item has been changed after the pre-scan and a re-scan has been executed, a transmission process is performed using the image data obtained by the re-scan. In a case where the start button 404 is pressed with no setting value of any setting item being changed after the pre-scan, the transmission process is performed using the image data obtained by the pre-scan. In a case where the start button 404 is pressed without a pre-scan instruction being issued on the scan-and-send screen 410, the original is scanned based on the scan settings at that time, and the scan-and-send process is performed using the image data obtained by the scan.

According to one or more embodiments, based on execution of a pre-scan, the MFP 101 identifiably displays the setting items for which a re-scan process is required in a case where their setting values are changed in an identifiable manner such that it is identifiable that a re-scan process is required in a case where their setting values are changed. Thus, the user may change the setting values of the setting items for which a re-scan is required even after a pre-scan has been executed. In addition, the user may easily recognize the setting items for which a re-scan is required in a case where their setting values are changed, perform a setting-value change operation after recognizing the corresponding setting items, and execute a re-scan. Thus, the user may cause the MFP 101 to generate image data based on desired setting values without requiring the user to reset reading settings from the beginning, thus improving usability.

### One or More Additional embodiments

Next, one or more additional embodiments will be described. In the aforementioned one or more embodiments, an example has been described in which a re-scan message is displayed in a case where any scan-setting item for which a re-scan is required has been changed. However, displaying a re-scan message each time a reading setting is changed may be bothersome for the user.

In one or more additional embodiments, an example is described in which, rather than displaying a re-scan message at the timing when a scan-setting item for which a re-scan is required is changed, a re-scan message is displayed at the timing when an instruction to execute a job (scan-and-send process) is issued. Specifically, even in a case where a scan-setting item for which a re-scan is required has been changed, the re-scan message is not displayed at that time, and the re-scan message is displayed at the timing when, after a scan-setting item is set and/or changed, the job execution instruction is issued.

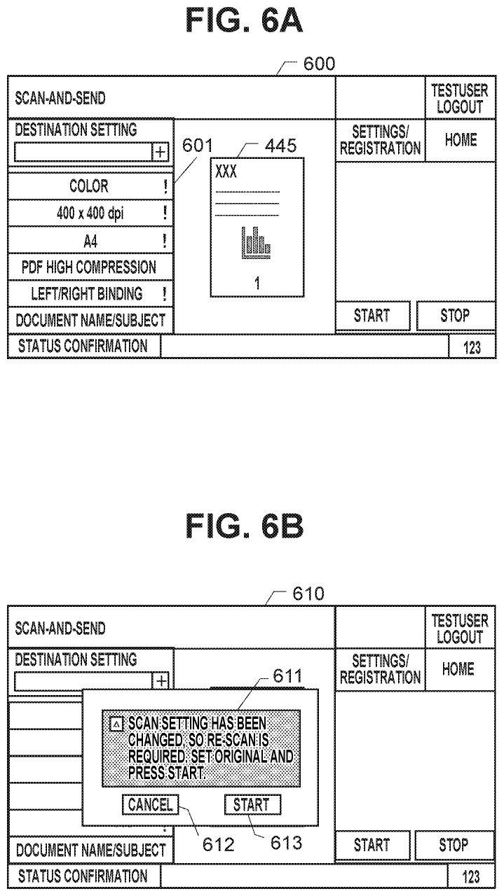

FIGS. 6A and 6B are diagrams illustrating examples of screens displayed on the operation unit 220 according to one or more additional embodiments.

Screens illustrated in FIGS. 6A and 6B are displayed by the screen display control unit 301.

FIG. 6A illustrates an example of a basic screen of the scan-and-send application after a setting change (hereinafter referred to as the scan-and-send screen 600). The scan-and-send screen 600 is displayed on the operation unit 220 in response to the reading-resolution setting on the scan-and-send screen 420 in the aforementioned one or more embodiments being changed from 300 dpi×300 dpi to 400 dpi×400 dpi. The reading-resolution button 601 displays 400 dpi×400 dpi, which is the changed setting value.

FIG. 6B illustrates an example of a re-scan screen 610 that prompts the user to perform a re-scan. The re-scan screen 610 is displayed on the operation unit 220 in response to the start button being pressed on the scan-and-send screen 600. The re-scan screen 610 includes a re-scan message 611, a cancel button 612, and a start button 613. The re-scan message 611 displays information indicating that, because a setting value of a scan-setting item has been changed, a re-scan is required to generate image data based on the changed setting value (e.g., message: “Scan setting has been changed, so re-scan is required. Set original and press START”). The cancel button 612 is used for canceling execution of the scan-and-send process. The start button 613 is used for performing a re-scan to obtain image data for the scan-and-send process.

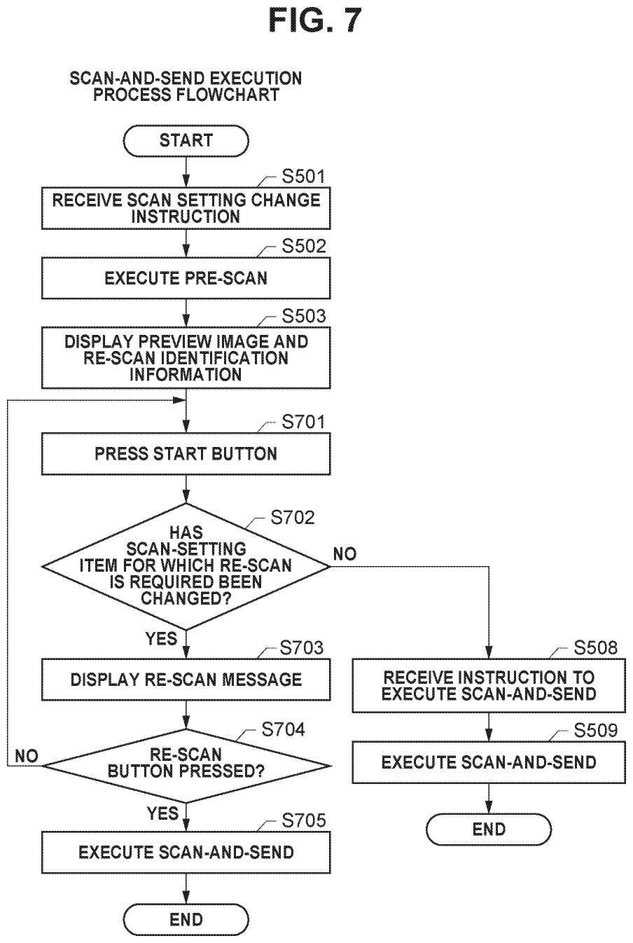

FIG. 7 illustrates an example of a flowchart of the scan-and-send execution process according to one or more additional embodiments. The flowchart illustrated in FIG. 7 is realized by the CPU 211 of the MFP 101 reading, into the RAM 213, programs stored in the ROM 212 for implementing respective control modules and executing the programs. Some or all of the functions performed in the steps in FIG. 7 may alternatively be realized in hardware, such as an ASIC or other electronic circuitry.

The flowchart illustrated in FIG. 7 is started based on the scan-and-send screen 410 being displayed in response to the user pressing the scan-and-send application 406. In addition, descriptions of steps assigned the same reference numerals as those in FIG. 5 are omitted because processes similar to those in FIG. 5 is performed.

In step S701, the screen input control unit 302 receives a press of the start button 404. For example, in a case where the scan-and-send screen 420 is displayed in step S503, the start button 404 is pressed after the user changes a scan-setting item.

In step S702, the application 304 determines whether any scan-setting item for which a re-scan is required has been changed. If the application 304 determines that a scan-setting item for which a re-scan is required has been changed (YES, in step S702), the processing proceeds to step S703. If the application 304 determines that no scan-setting item for which a re-scan is required has been changed (NO, in step S702), the processing proceeds to step S508.

In step S703, the screen display control unit 301 displays the re-scan screen 610 including the re-scan message 611.

In step S704, the screen input control unit 302 determines whether the start button 613 has been pressed on the re-scan screen 610. If the screen input control unit 302 determines that the start button 613 is pressed (YES, in step S704), the processing proceeds to step S705. If the screen input control unit 302 determines that the cancel button 612 is pressed (NO, in step S704), the processing returns to step S701.

In step S705, the application 304 executes the scan-and-send process. The application 304 performs a re-scan, and executes transmission processing using image data obtained by the re-scan.

According to one or more additional embodiments, the MFP 101 displays a re-scan message in a case where an instruction to execute a job is issued, rather than the timing when a scan-setting item for which a re-scan is required is changed. Thus, displaying the re-scan message each time a reading setting is changed may be less bothersome to the user.

### One or More Further Embodiments

Next, one or more further embodiments will be described. In the aforementioned one or more embodiments, an example has been described in which a re-scan message is displayed in a case where a setting item for which a re-scan is required is changed.

In the one or more further embodiments, a processing method is described for a case where, after a scan-setting item for which a re-scan is required has been changed, a further change to the scan-setting item makes the re-scan unnecessary. For example, in a case where a setting value of a scan-setting item for which a re-scan is required is changed and then the changed setting value is further changed back to a setting value used at the time of the pre-scan (i.e., an original setting value), the situation becomes similar to a case in which no setting change has been made, and thus a re-scan is unnecessary. In such a case, if the re-scan button 442 remains displayed, the user may execute a re-scan even though the re-scan becomes unnecessary.

Therefore, in one or more further embodiments, in a case where a re-scan becomes unnecessary, the scan-and-send screen 440 is displayed in a state in which the re-scan button 442 is not operable.

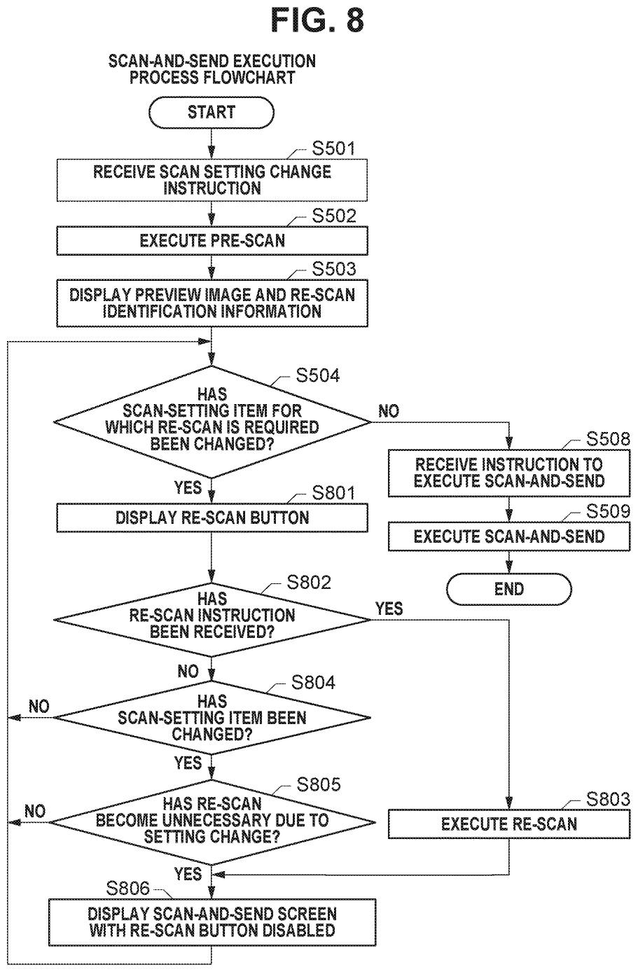

FIG. 8 illustrates an example of a flowchart of the scan-and-send execution process in one or more further embodiments. The flowchart illustrated in FIG. 8 is realized by the CPU 211 of the MFP 101 reading, into the RAM 213, programs stored in the ROM 212 for implementing respective control modules and executing the programs. Some or all of the functions performed in the steps in FIG. 8 may alternatively be realized in hardware, such as an ASIC or other electronic circuitry.

The flowchart illustrated in FIG. 8 is started based on the scan-and-send screen 410 being displayed in response to the user pressing the scan-and-send application 406. In addition, descriptions of steps assigned the same reference numerals as in FIG. 5 are omitted because processes similar to those in FIG. 5 is performed in those steps.

In step S801, the screen display control unit 301 displays the re-scan button 442. For example, the scan-and-send screen 440 including the re-scan button 442 is displayed on the operation unit 220 after the user changes the reading-resolution setting from 300 dpi×300 dpi to 400 dpi×400 dpi by pressing the reading-resolution button 422 and presses the re-scan-later button 433 on the re-scan screen 430.

In step S802, the screen input control unit 302 determines whether a re-scan instruction has been received. Specifically, the screen input control unit 302 determines whether the re-scan button 442 has been pressed. If the screen input control unit 302 determines that a re-scan instruction has been received (YES, in step S802), the processing proceeds to step S803. If the screen input control unit 302 determines that a re-scan instruction has not been received (NO, in step S802), the processing proceeds to step S804.

In step S803, the application 304 performs a re-scan and displays (updates) the preview image region 425 based on image data obtained by the re-scan.

In step S804, the screen input control unit 302 determines whether the setting value of any scan-setting item has been changed. If the screen input control unit 302 determines that a setting value of any scan-setting item has been changed (YES, in step S804), the processing proceeds to step S805. If the screen input control unit 302 determines that no setting value of any scan-setting item has been changed (NO, in step S804), the processing returns to step S504.

In step S805, the application 304 determines whether the re-scan has become unnecessary due to a setting value of a scan-setting item being changed. For example, in a case where the reading-resolution button 441 is pressed and the reading-resolution setting is changed from 400 dpi×400 dpi back to an original setting value (i.e., the scan setting value at the time of the pre-scan) of 300 dpi×300 dpi, the application 304 determines that the re-scan has become unnecessary. Even in a case where the setting values of a plurality of scan-setting items have been changed, the application 304 determines that the re-scan has become unnecessary based on the setting values of the plurality of changed scan-setting items being returned to the setting values at the time of the pre-scan. If the application 304 determines that the re-scan has become unnecessary (YES, in step S805), the processing proceeds to step S806. If the application 304 determines that the re-scan has not become unnecessary (NO, in step S805), the processing returns to step S504.

In step S806, the screen display control unit 301 displays the scan-and-send screen 440 in a state in which the re-scan button 442 is not operable (i.e., an operation on the re-scan button 442 cannot be accepted).

Specifically, the screen display control unit 301 displays the scan-and-send screen 440 without the re-scan button 442 (the re-scan button 442 is not displayed). Alternatively, the screen display control unit 301 displays the scan-and-send screen 440 with the re-scan button 442 grayed out.

According to one or more further embodiments, in a case where a re-scan becomes unnecessary, the MFP 101 displays a scan-and-send screen in a state in which a re-scan button is not operable, thereby reducing the possibility that the user might execute a re-scan even though the re-scan becomes unnecessary.

Thus, usability during scan execution may be improved.

### One or More Other Embodiments

Embodiment(s) of the present disclosure may also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to, and the benefit of, Japanese Patent Application No. 2025-057896, filed Mar. 31, 2025, which is hereby incorporated by reference herein in its entirety.

What is claimed is:

1. An image processing apparatus comprising:
a scanner that operates to read an original image or images; and
one or more processors that operate to display, on a display, image data of the original image or images read by the scanner,
wherein, based on an execution of a first reading process in which the original image or images are read by the scanner, the one or more processors further operate to, among a plurality of setting items relating to the first reading process, display, on the display, a setting item for which a second reading process in which reading of the original image or images is executed again is required in a case where a setting value is changed, in a manner such that a requirement for the second reading process is identifiable.

2. The image processing apparatus according to claim 1,
wherein the one or more processors further operate to display, on the display, a predetermined screen including a first region in which the plurality of setting items is displayed and a second region in which the image data of the original image or images read by the scanner is displayed, and
wherein, in a case where the first reading process is executed, the one or more processors further operate to display, on the display, a setting item, included in the first region, for which the second reading process is required, in a manner such that a requirement for the second reading process is identifiable.

3. The image processing apparatus according to claim 2, wherein the setting item, included in the first region, for which the second reading process is required is changeable with respect to a setting value.

4. The image processing apparatus according to claim 1, wherein, in a case where an operation to change a setting value of a setting item for which the second reading process is required is received and an instruction to execute transmission processing for transmitting the image data of the original image or images read by the scanner is received, the one or more processors further operate to display, on the display, information indicating that the second reading process is required.

5. The image processing apparatus according to claim 1, wherein, in a case where an operation to change a setting value of a setting item for which the second reading process is required is received, the one or more processors further operate to display, on the display, information indicating that the second reading process is required.

6. The image processing apparatus according to claim 5, wherein the information indicating that the second reading process is required is a message indicating that the second reading process is required.

7. The image processing apparatus according to claim 5, wherein the information indicating that the second reading process is required is a button configured to receive an instruction to execute the second reading process.

8. The image processing apparatus according to claim 7, wherein, in a case where the button configured to receive the instruction to execute the second reading process is operated, the scanner executes the second reading process.

9. The image processing apparatus according to claim 7,
wherein, in a case where an operation to change a setting value of a setting item for which the second reading process is required is received, a predetermined screen including a button configured to receive an instruction to execute the second reading process is displayed, and
wherein, further, in a case where another operation to change the setting value of the setting item for which the second reading process is required is received, the another operation being an operation to change the setting value of the setting item for which the second reading process is required to a setting value used in the first reading process, the predetermined screen is displayed in a state in which an operation on the button configured to receive the instruction to execute the second reading process is not acceptable or is disabled.

10. The image processing apparatus according to claim 9, wherein the state in which the operation on the button configured to receive the instruction to execute the second reading process is not acceptable or is disabled is a state in which the button configured to receive the instruction to execute the second reading process is not displayed.

11. The image processing apparatus according to claim 9, wherein the state in which the operation on the button configured to receive the instruction to execute the second reading process is not acceptable or is disabled is a state in which the button configured to receive the instruction to execute the second reading process is grayed out.

12. The image processing apparatus according to claim 1,
wherein, in a case where an instruction to execute the second reading process is received, the scanner executes the second reading process.

13. A control method for an image processing apparatus, the control method comprising:
reading an original image or images; and
performing display control of displaying image data of the original image or images obtained by the reading,
wherein, in a display control, based on an execution of a first reading process in which the original image or images are read through the reading, among a plurality of setting items relating to the first reading process, a setting item for which a second reading process in which reading of the original image or images is executed again is required in a case where a setting value is changed is displayed in a manner such that a requirement for the second reading process is identifiable.

14. A non-transitory computer-readable storage medium storing a program for causing a computer to execute a control method for an image processing apparatus, the control method comprising:
reading an original image or images; and
performing display control of displaying image data of the original image or images obtained by the reading,
wherein, in a display control, based on an execution of a first reading process in which the original image or images are read through the reading, among a plurality of setting items relating to the first reading process, a setting item for which a second reading process in which reading of the original image or images is executed again is required in a case where a setting value is changed is displayed in a manner such that a requirement for the second reading process is identifiable.
